(19) United States
(12) Patent Application Publication
(10) Pub. No.: US 2026/0289304 A1
(43) Pub. Date: Sep. 24, 2026

(54) Method for Stabilizing Neural Pathways in Early-Phase Artificial Neural Network Training with Initialization Imprints and Proportional Dynamic Adjustments.

(71) Applicant: Joshua Jarod Ely, Pennington Gap, VA (US)

(72) Inventor: Joshua Jarod Ely, Pennington Gap, VA (US)

(21) Appl. No.: 19/568,004

(22) Filed: Mar. 16, 2026

Related U.S. Application Data
(63) Continuation-in-part of application No. 19/001,566, filed on Dec. 26, 2024.

(51) Int. Cl. G06N 3/08; G06N 3/047

(52) U.S. Cl. CPC G06N 3/08; G06N 3/047

(57) ABSTRACT

A method and system for stabilizing neural pathways during early-phase artificial neural network training and accelerating convergence through proportional dynamic class weight adjustment. The method comprises a two-phase training protocol: an initial stabilization phase in which classes having model confidence at or below a predetermined threshold (less than or equal to 25%) are deprioritized by constraining their influence on parameter updates without eliminating them from training; and a dynamic adjustment phase in which the stability threshold is discontinued and class weights are dynamically adjusted proportionally to the gap between each class's accuracy and a target accuracy, whereby classes furthest from the target receive proportionally greater training emphasis. In a preferred embodiment, the initial stabilization phase generates a digital initialization training imprint comprising structural pathway selection biases derived from a single-pass assessment of the stochastic initialization landscape. This imprint persists into the dynamic adjustment phase without being reset, producing measurably improved training stability through trajectory path dependence. The method produces faster convergence to target accuracy (17-33% improvement), prevents late-training accuracy collapses (20% collapse reduction with persistent imprint), and achieves gradient signal inversion between easy and hard classes. The method has been validated across three independent domains: image classification, medical diagnosis, and financial regime classification, and across several neural network training architectures.

### CROSS-REFERENCE TO RELATED APPLICATIONS

This application is a continuation-in-part of U.S. application Ser. No. 19/001,566, filed Dec. 26, 2024, titled “Method for Stabilizing Neural Pathways in Early-Phase Artificial Neural Network Training,” the entire disclosure of which is incorporated herein by reference.

### FIELD OF THE INVENTION

The present invention relates to methods and systems for training artificial neural networks, and more particularly, to a two-phase confidence-informed training protocol that stabilizes neural pathway formation during early training and subsequently accelerates convergence through proportional dynamic class weight adjustment.

### BACKGROUND OF THE INVENTION

Artificial neural networks (ANNs) learn by iteratively adjusting connection weights through a process called backpropagation. During training, the model processes input data, computes a loss function measuring the difference between predicted and actual outputs, and propagates error gradients backward through the network to update weights. This process repeats over many iterations (epochs) until the model achieves satisfactory performance.

A persistent challenge in neural network training is class imbalance, where certain classes in the training data are significantly more prevalent than others. In such scenarios, the network's gradient updates are dominated by the majority classes during early training epochs when the model's predictions are essentially random (confidence levels below approximately 12.5% for a 10-class problem). This early dominance causes the network to form strong internal representations (neural pathways) for the majority classes before it has developed any meaningful understanding of the minority classes. Once these early pathways are established, subsequent training must work against the existing weight structure to build representations for the underrepresented classes, resulting in slower convergence and susceptibility to catastrophic accuracy collapses during late-stage training.

The prior art addresses class imbalance primarily through data-level methods (oversampling minority classes via SMOTE or similar techniques, undersampling majority classes), algorithm-level methods (cost-sensitive learning with fixed class weights proportional to inverse class frequency), and specialized loss functions (Focal Loss, which down-weights well-classified examples based on prediction confidence).

All prior art approaches share a common assumption: that classes where the model performs poorly should receive increased training emphasis immediately and throughout training. Focal Loss (Lin et al., 2017) reduces the loss contribution of well-classified examples from the first training step. Cost-sensitive learning applies fixed inverse-frequency weights before training begins. SMOTE generates synthetic minority examples to increase their representation in the training set. Each of these approaches attempts to correct class imbalance by immediately boosting the influence of underperforming or underrepresented classes.

The inventor has discovered, through both theoretical analysis and extensive experimental validation, that this universal approach is counterproductive during the initial training phase. Immediately boosting underperforming classes when the model's confidence is below a stability threshold (specifically, less than or equal to 25%) causes the model to form neural pathways based on effectively random gradient signals. These unstable pathways actively resist correction during later training, leading to slower convergence and episodic accuracy collapses. The inventor's discovery that temporarily constraining (rather than boosting) low-confidence classes during early training produces faster convergence is counterintuitive and teaches away from the entire body of prior art on class imbalance.

### Technical Problem

The prior art fails to recognize that the timing of class weight adjustment relative to the model's confidence development is critical to training efficiency. Standard approaches apply class rebalancing uniformly from the start of training. This causes three specific technical problems:

First, premature pathway commitment. During the first several training epochs, the model's predictions are near-random (confidence approximately 1/N for N classes). Gradient updates from these unreliable predictions cause the network to form internal representations that do not reflect genuine class structure. For majority classes, the sheer volume of gradient signal reinforces these premature representations, making them difficult to modify later. For minority classes, the weak and noisy gradient signal produces fragile pathways that are easily disrupted by subsequent updates.

Second, late-training accuracy collapses. Experimental data demonstrates that standard training produces episodic accuracy drops of 3-4 percentage points during late training (e.g., at epochs 23 and 27 of a 31-epoch training run on CIFAR-10), where the model's overall accuracy drops suddenly before recovering. These collapses occur because the fragile minority-class pathways, which were formed during the chaotic early training phase, are disrupted by gradient updates from confounding examples. The model must then spend additional epochs rebuilding these pathways.

Third, inefficient gradient allocation. Throughout standard training, the majority classes continue to receive gradient signal proportional to their prevalence in the dataset, even after the model has already achieved high accuracy on those classes. This wastes computational resources on classes that do not need further training, while the minority classes that determine the bottleneck for overall accuracy receive insufficient gradient signal.

Additionally, the prior art approaches that do adjust class weights dynamically (such as Focal Loss) operate at the individual sample level based on prediction confidence, not at the class level based on the gap between class accuracy and a target threshold. This distinction is significant: a class may contain individual samples that are well-classified (high sample-level confidence) while the class as a whole remains far below the target accuracy. Sample-level approaches cannot detect this class-level deficiency.

### Technical Solution

The present invention addresses these problems through a two-phase confidence-informed training protocol with proportional dynamic adjustment. The method comprises:

Phase 1—Initial Stabilization: During the initial training epochs, the method monitors the model's per-class confidence metrics. For any class where the model's confidence is at or below a predetermined stability threshold (specifically, a value less than or equal to 25%), the method constrains the influence of that class's data on the network's parameter updates by applying a deprioritization weight (a value less than 1.0 but greater than zero, such as any value from 0.001 to 0.9) to the loss function for examples belonging to that class. This constraint prevents the formation of unstable neural pathways from near-random gradient signals during the period when the model's predictions are unreliable. Critically, the constraint reduces without eliminating the class's influence, preserving the model's exposure to all classes throughout training.

The stability threshold of 25% or less is specifically chosen based on both theoretical and empirical considerations. At 25% confidence for a 10-class problem (where random performance is 10%), the model has demonstrated meaningful learning above chance for that class. For those classes below 25%, the model's predictions are insufficiently reliable to form stable gradient signals, which is why those classes and weights are deprioritized. The inventor has empirically demonstrated that setting this threshold significantly higher (e.g., 95%) causes a catastrophic feedback loop: deprioritization reduces accuracy, which triggers further deprioritization, driving the model to near-random performance from which it cannot recover. The 25% threshold represents the stability boundary below which the protocol is self-correcting (the model naturally exits Phase 1 within several epochs) and above which it becomes self-destructive.

Phase 2—Dynamic Proportional Adjustment: After the model's mean class confidence exceeds a transition threshold (or after a predetermined number of stabilization epochs), the method discontinues the fixed stability threshold and instead dynamically adjusts class weights based on the model's ongoing per-class accuracy relative to a target accuracy. In one embodiment, this adjustment is proportional: for each class whose accuracy falls below the target, the class weight is increased by a factor that scales with the magnitude of the gap between the class's current accuracy and the target. Classes that are furthest from the target accuracy receive proportionally greater training emphasis, while classes that have already achieved the target receive no additional weight. This proportional adjustment is applied periodically (e.g., every N epochs) to allow the model to respond to the adjusted weights before further modification.

In one embodiment, the proportional adjustment is computed as:

$${w}_{c} = {w}_{c} \times ( 1. + β \times ( 1.0 + gap\_c / target ) )$$

where w_c is the weight for class c, β is a base boost factor (e.g., 0.1), gap_c is the difference between the target accuracy and class c's current accuracy (gap_c=target−accuracy_c), and target is the target accuracy threshold. When gap_c≤0 (class accuracy meets or exceeds the target), no adjustment is applied to class c.

In another embodiment, the dynamic adjustment uses a uniform boost factor: for each class whose accuracy falls below the target, the class weight is multiplied by a fixed factor (e.g., 1.2) regardless of the magnitude of the gap. This uniform embodiment is simpler but less efficient than the proportional embodiment, as it allocates equal additional gradient to all underperforming classes regardless of their distance from the target.

Phase Transition Mechanisms: The transition from Phase 1 to Phase 2 may be implemented through several mechanisms. In one embodiment, the transition occurs when the model's mean per-class confidence exceeds a confidence threshold (e.g., 50%). In another embodiment, the transition occurs after a fixed number of stabilization epochs (e.g., 5 epochs). In a further embodiment, the transition is smooth: the Phase 1 and Phase 2 weights are interpolated over a window of epochs (e.g., 10 epochs) using a cosine interpolation function, so that the training protocol gradually shifts from stabilization to dynamic adjustment without an abrupt change. In yet another embodiment, the stability threshold decays adaptively (e.g., multiplied by a decay factor each epoch), so that Phase 1 naturally fades as the threshold approaches zero.

Sample-Level Deprioritization: In an additional embodiment, the method operates at the individual sample level rather than (or in addition to) the class level. For each training example, the model's confidence in the correct class is computed. Examples where this confidence falls below a sample-level threshold (e.g., 15%) have their gradient contribution reduced by a sample-level deprioritization weight (e.g., 0.85). This captures confounding examples within otherwise well-performing classes, such as a cat image that closely resembles a dog, where the class-level accuracy may be adequate but the individual example produces destabilizing gradient updates.

### DETAILED DESCRIPTION OF EMBODIMENTS

The present invention is implemented in a server computing system comprising a processor and a non-transitory memory storing instructions that, when executed, cause the system to perform the operations described herein. The system creates a plurality of neural network nodes organized in at least one input layer, at least one hidden layer, and at least one output layer. Multi-class digital data is input into memory, and initial class weights are received from the processor stochastically.

The training process begins with an Initial Stabilization Phase (Phase 1). During this phase, the model's confidence metrics are monitored after each training epoch. A Confidence Assessment Module computes, for each class c in the training data, the mean predicted probability that the model assigns to class c for samples whose true label is c. This per-class confidence metric indicates how reliably the model can identify each class.

A Class Weight Adjustment Module then examines each class's confidence against the predetermined stability threshold (≤25%). For any class whose confidence falls at or below this threshold, the module assigns a deprioritization weight (e.g., 0.9) to that class. For classes whose confidence exceeds the threshold, the weight remains at 1.0. These per-class weights are applied to the loss function: L(xᵢ, yᵢ, θ)=w_{[y}_{ᵢ}_{]}·L(f_{θ}(xᵢ),(yᵢ)), where w_{[y}_{ᵢ}_{]} is the weight assigned to the true class of example i. During backpropagation, the gradient flowing from deprioritized classes is reduced by the deprioritization factor, diminishing without eliminating that class's influence on the network's weight updates.

At each epoch during Phase 1, the class-specific nature of the deprioritization evolves. At the very first epoch (epoch 0), the model has random initial weights and all classes typically have confidence near 1/N (where N is the number of classes), so all or nearly all classes may be deprioritized. By epoch 1 or 2, the easy classes (those with high prevalence and distinctive features) rapidly exceed the 25% threshold and return to full weight, while the hard classes (those with low prevalence, confounding features, or label noise) remain below the threshold and continue to be constrained. This class-specific differentiation is the key mechanism of Phase 1: it prevents the easy classes from monopolizing the gradient signal during the critical early epochs when the network's internal representations are forming.

A Phase Transition Module monitors the model's overall confidence and triggers the transition to the Dynamic Adjustment Phase (Phase 2) when a transition criterion is met. In the hard transition embodiment, Phase 2 begins instantaneously when the criterion is met. In the smooth transition embodiment, the Phase 1 weights (w1) and Phase 2 weights (w2) are blended according to: w=(1−α)·w1+α·w2, where α increases from 0 to 1 over the transition window using cosine interpolation: α=0.5×(1−cos(π×t/T_window)), and t is the number of epochs since the transition began.

During Phase 2, the Dynamic Adjustment Module periodically (every N epochs) evaluates each class's accuracy against the target accuracy. In the proportional embodiment, for each class c whose accuracy_c<target, the class weight is increased according to: w_c=w_c×(1.0+β×(1.0+ (target-accuracy_c)/target). This formula allocates more gradient to classes that are furthest from the target, directing the model's learning capacity where it is most needed. For example, with β=0.1 and target=90%: a class at 40% accuracy receives w_c×1.156; a class at 70% accuracy receives w_c×1.122; a class at 85% accuracy receives w_c×1.106. The proportional scaling ensures that the hardest classes receive approximately 45% more boost than classes that are nearly at target.

In the sample-level embodiment, an additional Sample Confidence Module evaluates the model's confidence on each individual training example. For each example x_i with true class y_i, the model computes P(y_i|x_i). If this probability falls below a sample-level threshold (e.g., 0.15), the example's gradient contribution is scaled by a sample-level weight (e.g., 0.85). This per-sample weighting operates in conjunction with the per-class weighting, providing fine-grained control over which data points influence training.

The combination of Phase 1 (pathway stabilization) followed by Phase 2 (proportional dynamic adjustment) forms a Neural Network Early Pathway Training Stabilizer Module. This module may be implemented in software executing on a general-purpose processor, a Graphics Processing Unit (GPU), a Tensor Processing Unit (TPU), in dedicated hardware, or in a combination thereof.

Scaled Parameter Update Regulation: In an additional embodiment, the stabilization protocol employs a continuous scaling mechanism rather than a binary accept/reject mechanism for constraining parameter updates. When the magnitude of a proposed parameter update exceeds a regulation threshold γ (as measured by a bounded saturation function w applied to the norm of the update), the system computes a scaling factor α∈(0, 1] such that the scaled update satisfies the regulation threshold. The scaled update is computed as: x_{t+1}=x_t+α·(F(x_t)−x_t), where α is the largest value satisfying ψ(α·∥F(x_t)−x_t|)≤γ. When the unscaled update already satisfies the threshold, α=1 and the update is applied without modification. This scaled regulation preserves the direction of the parameter update while constraining its magnitude, retaining the directional information of the gradient signal while preventing single-step destabilization. In the context of neural network training, this means that when a training batch produces an unusually large gradient (for example, due to a batch that is heavily weighted toward confounding examples), the update direction is preserved but its magnitude is reduced to the boundary of the admissible region, rather than being rejected entirely. As used herein, a bounded saturation function y is any mathematical function that maps an input value to a constrained range, such as a sigmoid function, a hyperbolic tangent (tanh) function, or a gradient clipping threshold function.

Convergence Detection via Trajectory Functional Monitoring: In a further embodiment, the system monitors the per-step contribution to the cumulative trajectory functional (the bounded saturation function applied to each parameter update norm) as a convergence indicator. As the iterative training process approaches convergence, the magnitude of parameter updates decreases, causing the per-step functional contribution ψ(|x_t−x_{t−1}∥) to approach zero. The system detects convergence by monitoring when the per-step contribution falls below a convergence threshold ε for a predetermined number of consecutive epochs (e.g., 5 consecutive epochs with ψ(δ_t)<ε). This convergence detection mechanism operates independently of the validation accuracy metric and provides a complementary signal based on the internal dynamics of the parameter trajectory. In one embodiment, the system automatically terminates training when convergence is detected, reducing unnecessary computation. In another embodiment, the system uses the convergence signal to trigger a transition between training phases (e.g., from Phase 2 to a fine-tuning phase with reduced learning rate).

Training Trajectory Budget Monitor: In yet another embodiment, the system tracks the cumulative value of the trajectory functional S=Σψ(∥x_t−x_{t−1}∥) during training and computes a utilization ratio U=S/B, where B is a predetermined training trajectory budget. The utilization ratio U∈[0, 1] indicates what fraction of the total allowable trajectory variation has been consumed by the training process to date. When U approaches 1.0, the training process has consumed substantially all of its variation budget, indicating that further training epochs are unlikely to produce significant parameter changes. In one embodiment, the system provides the utilization ratio as a real-time training diagnostic, enabling automated training management systems to allocate computational resources across multiple concurrent training jobs based on each job's remaining trajectory budget. In another embodiment, the system uses the trajectory budget to enforce a hard constraint on total training variation: if S reaches B, training is halted regardless of the current accuracy. This prevents over-training scenarios where the model continues to make large parameter updates without corresponding accuracy improvement. The trajectory budget B may be set based on the theoretical maximum T·M (where T is the total number of planned epochs and M is the upper bound of w), or may be set empirically based on prior training runs on similar data.

Persistent Initialization Imprint (or fingerprint): In a further embodiment, the Phase 1 stabilization protocol is implemented as a single-pass assessment of the stochastic initialization landscape, wherein the resulting class weight adjustments persist into Phase 2 without being reset to uniform values at the phase transition. Specifically, before the first training epoch (or during the first training epoch), the system assesses the model's per-class confidence metrics based on the randomly initialized network weights-unique for every initialization. For each class whose initial confidence falls at or below the stability threshold (≤25%), the system applies a deprioritization weight (e.g., 0.99) that is retained as the starting weight for that class when Phase 2 begins. Regardless of if phase 1 is triggered to even begin any training in and of itself, its initial resulting weight configuration constitutes a digital artifact of stable neural pathway selection biases, even if applied before training begins, or if done early in training epochs. Unlike the hard-transition embodiment described in paragraph [0025], the persistent imprint embodiment does not reset class weights to uniform values upon entering Phase 2. Instead, the Phase 2 dynamic adjustment (boosting underperforming classes) operates on top of the Phase 1 imprint, so that classes identified as weak during the stochastic assessment accumulate a slightly different weight trajectory than classes identified as strong. This persistent bias compounds across successive Phase 2 boost cycles, producing measurably different training stability characteristics at late epochs even though the initial perturbation is as small as 1%. The persistent imprint embodiment has the advantage of introducing no additional training cost—the Phase 1 assessment adds no training epochs—while providing late-training stability benefits through the compounding effect of the initialization-informed weight trajectory. Please note in the figures this imprint is referred to as a “fingerprint.”

Trajectory Path Dependence of Neural Network Training: The inventor has discovered, through controlled experimentation, that neural network training trajectories exhibit persistent sensitivity to initial class weight conditions. Specifically, a perturbation of as little as 1% to the class weights at epoch 0 (applying a deprioritization weight of 0.99 to low-confidence classes identified during the stochastic initialization assessment) produces a statistically distinguishable training stability profile at epochs 30-40 and beyond. This discovery demonstrates that neural network weight configurations carry persistent memory of early training conditions: the gradient updates at each epoch are computed from the current weight state, which was produced by all prior gradient updates, each of which was influenced by the class weights in effect at the time of the update. A perturbation to the class weights at epoch 0 therefore enters a recurrence relation that propagates through every subsequent training step, compounding across epochs. The practical consequence of this path dependence is that the Phase 1 stabilization protocol—even when implemented as an ultra-light imprint—leaves a persistent structural bias in the network's . . . weight space that influences training stability throughout the entire training run. This is the mechanistic basis for the observed reduction in late-training accuracy collapses: the Phase 1 imprint biases the weight trajectory away from regions of the weight space that are susceptible to collapse, and this bias persists because training trajectories do not converge to the same point regardless of initial conditions, contrary to the conventional assumption in the field.

Initialization-Informed Trajectory Control: The discoveries described in paragraphs [0032] and [0032a] establish a new category of neural network training intervention: using information from the stochastic initialization to control the stability properties of the subsequent training trajectory. The Phase 1 stabilization protocol, in all its embodiments (hard transition, smooth transition, persistent imprint, adaptive decay), operates on this principle: it reads the stochastic landscape established by random weight initialization, identifies which classes are predisposed to unstable learning (those with low initial confidence), and applies a targeted intervention that shapes the trajectory of subsequent training. This is distinct from prior art initialization techniques (He initialization, Xavier initialization, batch normalization) which address the scale and distribution of the network weights themselves, rather than using the information contained in the initialized state to inform the subsequent training protocol. The present invention treats the stochastic initialization not as noise to be overcome but as information to be exploited.

### Sinusoidal Learning Trajectory.

Experimental observation of the two-phase confidence-informed training protocol described herein reveals a characteristic learning velocity pattern that is structurally distinct from the monotonic deceleration observed in standard training. In standard neural network training without confidence-based class weighting, the per-epoch accuracy gain (learning velocity) decays monotonically: high in early epochs and decreasing continuously toward a ceiling. By contrast, the two-phase protocol of the present invention produces a sinusoidal learning trajectory in which learning velocity oscillates rather than decays monotonically.

Specifically, the training trajectory produced by the two-phase protocol exhibits the following sequence of velocity phases: (1) an elevated velocity at epoch 1 arising from Phase 1 stabilization prior to dynamic adjustment engagement; (2) a velocity dip during the Phase 1 to Phase 2 transition window, wherein the blending of Phase 1 constraint weights with Phase 2 dynamic weights temporarily reduces per-epoch accuracy gains below the baseline; (3) a mid-training velocity surge wherein learning velocity recovers and exceeds the baseline by a measurable margin; and (4) a final decay toward the accuracy ceiling. The velocity dip followed by amplified recovery constitutes one complete oscillation of the sinusoidal pattern.

Empirical measurement of this pattern across two independent random seeds demonstrates that the velocity recovery following the Phase 1-to-Phase 2 transition produces a bounce-back ratio of approximately 2.38×—that is, the magnitude of the post-transition velocity surge relative to the pre-transition velocity dip is approximately 2.38 times the dip magnitude. This ratio is substantially greater than unity, confirming that the transition dip is not merely recovered but is amplified into a net positive acceleration. Furthermore, natural secondary velocity oscillations have been observed at later training epochs (approximately epochs 10-15 and 20-25) at reduced amplitude, consistent with a damped sinusoidal pattern across the full training run.

The sinusoidal trajectory arises because Phase 1 confidence-based pathway stabilization creates a specific structural organization of neural network weights that Phase 2 dynamic adjustment can exploit more efficiently than a randomly initialized weight configuration. The temporary Phase 1-to-Phase 2 transition cost reflects a brief reorganization period during which the network adapts from constrained to dynamic weighting; the subsequent velocity surge reflects Phase 2 operating on a better-organized weight configuration than would be available to a network trained without Phase 1.

### Periodic Re-Dampening.

In an additional embodiment, the training protocol applies confidence-based class weight dampening at one or more scheduled intervention points during training, in addition to the initial Phase 1 dampening applied at training initialization. This embodiment is referred to herein as periodic re-dampening. The periodic re-dampening protocol exploits the sinusoidal learning trajectory described in paragraph by deliberately inducing a velocity dip at a scheduled epoch, thereby triggering an amplified velocity recovery in the subsequent training window.

In the periodic re-dampening embodiment, the system maintains a schedule of one or more re-dampening epochs (e.g., epoch 15 and epoch 25) at which the confidence scanner described in paragraph is re-invoked. At each scheduled re-dampening epoch, the system: (i) assesses the current per-class confidence distribution; (ii) identifies classes whose confidence falls below the confidence threshold; (iii) computes class weights using the proportional boost formula of paragraph [0016] or the uniform boost formula of paragraph [0017]; and (iv) applies the computed class weights for a re-dampening window of N epochs before releasing the weights back to Phase 2 dynamic adjustment. The re-dampening window duration N is a configurable parameter, with a default value of approximately 3 epochs.

The periodic re-dampening protocol produces a multi-wave sinusoidal learning trajectory in which each scheduled re-dampening event induces a velocity dip followed by an amplified recovery, compounding the beneficial effects of the initial Phase 1 stabilization across multiple points in the training run. The magnitude of each subsequent bounce-back may be less than the initial Phase 1 bounce-back ratio due to increasing network consolidation with training progress; however, each re-dampening event is expected to produce a net positive velocity contribution over the re-dampening window.

The periodic re-dampening embodiment is particularly beneficial in long training runs (e.g., runs exceeding 20 epochs) where the natural velocity decay of Phase 2 dynamic adjustment would otherwise produce diminishing returns in later training epochs. By inducing periodic reorganization of class weight influence, the periodic re-dampening protocol maintains higher average learning velocity across the full training run compared to Phase 2 dynamic adjustment alone.

### Velocity-Triggered Adaptive Re-Dampening.

In a further embodiment, the periodic re-dampening described in paragraph is applied adaptively based on real-time monitoring of learning velocity rather than at fixed scheduled epochs. This embodiment is referred to herein as velocity-triggered adaptive re-dampening. Rather than firing at predetermined epoch intervals, the adaptive re-dampening protocol monitors the per-epoch accuracy velocity and fires a re-dampening event automatically when the velocity drops below a triggering threshold relative to a recent reference velocity.

In the velocity-triggered adaptive re-dampening embodiment, the system maintains a rolling estimate of the current learning velocity v_t computed as the per-epoch accuracy gain over a recent window of epochs. The system also maintains a reference velocity v_ref computed as the average velocity over a prior reference window. A re-dampening event is triggered when the ratio v_t/v_ref falls below a velocity trigger threshold T_v (e.g., T_v=0.70, meaning current velocity has dropped to 70% or less of the reference velocity). An additional guard condition requires that the per-class accuracy spread—defined as the difference between the highest-accuracy and lowest-accuracy classes—exceeds a minimum spread threshold S_min (e.g., S_min=15 percentage points), ensuring that re-dampening is only applied when meaningful class imbalance remains and the reorganization benefit is likely to be positive.

Upon triggering, the velocity-triggered adaptive re-dampening protocol applies the same re-dampening window procedure described in paragraph [0034]. The re-dampening event is applied for a configurable window of N epochs, after which Phase 2 dynamic adjustment resumes. To prevent excessive re-dampening in unstable training runs, the protocol enforces a minimum interval between consecutive re-dampening events (e.g., a minimum of 5 epochs between events).

The velocity-triggered adaptive re-dampening embodiment offers the advantage of self-regulation: the re-dampening protocol responds to the actual learning dynamics of the specific model and dataset rather than firing at predetermined epochs that may not align with the model's natural velocity decay pattern. This makes the adaptive embodiment more generally applicable across diverse model architectures, dataset characteristics, and training durations than the fixed-schedule periodic re-dampening embodiment.

### Advantageous Effects

The present invention provides the following technical improvements to the functioning of artificial neural networks, each of which has been empirically demonstrated through controlled experimentation:
1. Improved Training Efficiency. The two-phase protocol reduces the number of training epochs required to reach a target accuracy. Experimental results demonstrate 9.63% faster convergence on CIFAR-10 image classification (99.52% accuracy in 28 epochs vs. 31 epochs for standard training), 17.4% faster convergence on a medical/digit classification task (Wilcoxon signed-rank test, p=0.001, 15 seeds), 33.1% faster convergence on a financial regime classification task (Wilcoxon signed-rank test, p=0.008, 15 seeds), and 19.8% faster convergence when using the proportional boost embodiment on the medical classification task (Wilcoxon signed-rank test, p=0.002, 15 seeds). Combined across two domains and 30 paired observations, the improvement is significant at p=0.000089.
2. Enhanced Model Accuracy at Equivalent Compute. Because the method reaches target accuracy in fewer epochs, at any fixed training budget (number of epochs), the model trained with the present method is more accurate than the model trained with standard methods. This is the standard definition of training efficiency in the machine learning literature.
3. Prevention of Late-Training Accuracy Collapses. Experimental data from CIFAR-10 training demonstrates that the standard model suffers two major accuracy collapses during late training: a 4.41 percentage point drop at epoch 23 (from 92.51% to 88.10%) and a 3.63 percentage point drop at epoch 27 (from 96.02% to 92.39%). The model trained with the present method exhibits no comparable collapses, with a maximum single-epoch accuracy drop of only 2.95 percentage points. This structural resilience arises because Phase 1 prevents premature pathway commitment, producing hard-class pathways that are more robust to gradient perturbations during late training.
4. Gradient Signal Inversion. Experimental analysis of the gradient dynamics demonstrates that the present method reverses the gradient signal ratio between easy and hard classes. In standard training, the easy-class-to-hard-class gradient ratio remains above 1.0 throughout training (approximately 1.12 to 1.16), meaning easy classes always dominate the gradient signal. With the present method, this ratio drops below 1.0 by approximately epoch 22, reaching 0.85 by epoch 28, meaning hard classes contribute more gradient signal than easy classes during the critical convergence phase. This gradient signal inversion is the mechanism by which the method accelerates convergence: it redirects gradient from classes that no longer need it to classes that determine the accuracy bottleneck.
5. Improved Handling of Class Imbalance. The method is particularly effective when training data contains classes of significantly different prevalence, as is common in real-world applications such as medical diagnosis (where rare conditions may comprise less than 5% of training data) and financial regime classification (where crisis events may comprise less than 5% of historical data).
6. Flexibility and Versatility. The method's parameters (stability threshold, deprioritization weight, boost factor, transition timing) can be tuned to optimize for different objectives: earlier transition for maximum convergence speed, later transition for improved rare-class performance. Both operating points produce statistically significant improvements over standard training.
7. Real-Time Adaptability. The dynamic Phase 2 adjustment responds to the model's actual per-class performance during training, automatically directing additional gradient to whichever classes are currently underperforming. No manual intervention or prior knowledge of class difficulty is required.
8. Domain Independence. The technical improvement has been demonstrated across three independent domains (image classification, medical diagnosis classification, and financial regime classification) using the identical protocol, demonstrating that the improvement arises from the method itself rather than any characteristic of a specific dataset.
9. Directional Preservation under Regulation. The scaled parameter update regulation (claim 11) preserves the direction of gradient updates while constraining their magnitude, retaining informative gradient signal even when the update magnitude is excessive. This prevents the information loss that occurs with binary accept/reject regulation, where an entire gradient step is discarded when it exceeds the threshold.
10. Automatic Convergence Detection. The trajectory functional convergence detection (claim 13) provides an internal signal for detecting training convergence based on the parameter trajectory dynamics, independent of validation set accuracy. This enables automated training termination or phase transitions without requiring a held-out validation set evaluation at every epoch.
11. Training Resource Management. The trajectory budget monitor (claim 15) provides a real-time metric of training progress based on the cumulative parameter trajectory variation, enabling automated systems to manage computational resources across multiple concurrent training processes based on each process's remaining variation budget.
12. Training Trajectory Stability Through Persistent Initialization Imprint. The persistent imprint embodiment (claim 17) reduces the frequency and severity of late-training accuracy collapses by embedding an initialization-informed bias into the class weight trajectory. Experimental results demonstrate that the persistent imprint reduces total collapse events by 20% (66 collapses vs. 83 for Phase 2 alone across 20 seeds) and reduces worst-case single-seed collapse severity by more than 50% (19 collapse events in the worst seed vs. 43 for Phase 2 alone). This stability improvement is achieved with a deprioritization weight of 0.99 (a 1% perturbation), demonstrating that the effect arises from the trajectory path dependence of the training process rather than from the magnitude of the perturbation itself. Other such deprioritization weights may be used for various other effects as well, including ranges from 0.90 to 0.99,
13. Exploitation of Stochastic Initialization Information. The present invention is the first method, to the inventor's knowledge, that reads the information contained in the stochastic initialization of a neural network and uses that information to inform the subsequent training protocol. Prior art initialization techniques (He initialization, Xavier initialization) address the statistical properties of the initialized weights but do not extract class-specific information from the initialized state. The present method's Phase 1 assessment—which identifies which classes have high vs. low initial confidence—extracts information about the relationship between the random weight configuration and the class structure of the training data, and uses that information to apply targeted interventions that persist throughout training.

### Experimental Results

The following experimental results have been obtained by the inventor and are presented in support of the claimed technical improvements. All results are based on controlled experiments with paired comparisons (identical network architecture, initialization, and hyperparameters), using the Wilcoxon signed-rank test for statistical significance.
Experiment 1: CIFAR-10 Image Classification (Parent Application Data). The inventor implemented the claimed method on CIFAR-10, a standard 10-class image classification benchmark containing 50,000 training images of 32×32 pixels in 10 classes (airplane, automobile, bird, cat, deer, dog, frog, horse, ship, truck). Using a convolutional neural network with two convolutional layers and two fully connected layers, trained with SGD (learning rate 0.01, momentum 0.5, step learning rate schedule), the following results were obtained:
   1. Standard Training: 99.74% accuracy in 31 epochs (943.55 seconds)
   2. Claimed Method: 99.52% accuracy in 28 epochs (852.69 seconds)
   3. Improvement: 9.63% faster training time

The claimed method exhibited a characteristic training profile: (a) a substantial first-epoch accuracy advantage of 8.48 percentage points (40.83% vs. 32.35%); (b) a period from epochs 2-9 where the claimed method temporarily underperformed the standard method; (c) recovery and permanent lead from approximately epoch 13; and (d) faster convergence to the 99.5% accuracy threshold. The standard model suffered two major late-training accuracy collapses at epochs 23 (−4.41 pp) and 27 (−3.63 pp), while the claimed method showed no comparable collapses.
Experiment 2: Medical/Digit Classification (15 Seeds). A digit classification task was constructed with realistic medical data characteristics: class imbalance (classes 5-9 subsampled to 20% of original), confounding label noise (similar-looking digit pairs flipped at 10-20% rate: 8↔3, 5↔6, 9↔4), and feature noise (Gaussian noise added at σ=0.25). Three methods were compared across 15 random seeds:
   1. Standard Training: Mean 28.0 epochs to reach 72% accuracy
   2. Claimed Method (base patent): Mean 23.1 epochs (17.4% faster, Wilcoxon p=0.001)
   3. Reversed Method (prior art direction): Mean 45.7 epochs (63.3% SLOWER, Wilcoxon p=0.004)
   Win/Tie/Loss record for the claimed method vs. standard: 11/3/1.
   Win/Tie/Loss record for the claimed method vs. reversed: 13/1/1 (Wilcoxon p=0.0008).

The reversed method—which boosts hard classes and demotes easy classes during Phase 1, then reverses in Phase 2—is the approach that the prior art would motivate, as it immediately increases emphasis on underperforming classes. This approach is not merely ineffective; it is catastrophically worse than standard training, frequently failing to converge within the 80-epoch maximum. This result constitutes strong evidence of teaching away.
Experiment 3: Financial Regime Classification (15 Seeds). A financial market regime classification task was constructed with 7 classes (Bull, Bear, Range, High Volatility, Breakout, Crash, Recovery), 12 features, and confounding overlap between related regimes (e.g., Crash overlaps with Bear and High Volatility). Three methods were compared across 15 random seeds:
   1. Standard Training: Mean 16.5 epochs to reach 75% accuracy
   2. Claimed Method: Mean 11.1 epochs (33.1% faster, Wilcoxon p=0.008)
   3. Reversed Method: Mean 51.1 epochs (208.9% SLOWER, Wilcoxon p=0.004) Win/Tie/Loss record for the claimed method vs. standard: 7/7/1 (88% win rate excluding ties).
   Win/Tie/Loss record for the claimed method vs. reversed: 11/3/1 (Wilcoxon p=0.0007).
Experiment 4: Proportional Boost Embodiment (15 Seeds). The proportional boost embodiment (claim 2) was compared against the base patent method and standard training on the medical classification task:
   1. Standard Training: Mean 28.9 epochs to 72% accuracy
   2. Base Patent (uniform boost): Mean 25.5 epochs (11.8% faster, p=0.03)
   3. Proportional Boost: Mean 23.2 epochs (19.8% faster, p=0.002)

The proportional boost embodiment achieves nearly double the speedup of the uniform boost embodiment, with an order of magnitude stronger statistical significance (p=0.002 vs. p=0.03). Win/Tie/Loss vs. standard: 10/4/1.
Experiment 5: Combined Cross-Domain Significance. Pooling paired observations across both the medical and financial domains (30 total paired observations), the combined Wilcoxon signed-rank test yields:
   Claimed Method vs. Standard: p=0.000089
   Reversed Method vs. Standard: p=0.000152 (reversed is significantly worse)
Experiment 6: Gradient Signal Analysis. Detailed analysis of per-class gradient norms throughout training reveals the mechanism of the method's improvement. In standard training, the ratio of easy-class gradient signal to hard-class gradient signal remains above 1.0 throughout all epochs (range: 1.11 to 1.16), meaning easy classes permanently dominate the gradient. With the claimed method, this ratio begins similarly but decreases through Phase 2 as the boosting takes effect, crossing below 1.0 at approximately epoch 22 and reaching 0.85 by epoch 28. This gradient signal inversion—where hard classes contribute more gradient signal than easy classes—is something standard training never achieves. It is the mechanism by which the method accelerates convergence: by directing the model's learning capacity toward the classes that determine the bottleneck for overall accuracy.
Experiment 7: Stability Threshold Boundary Analysis. The inventor tested the claimed method with the stability threshold set to 95% (rather than 25%). The model initially trained normally, approaching approximately 90-92% accuracy, at which point most classes began fluctuating near the 95% threshold. When any class dipped below 95% confidence on a given epoch, it was deprioritized, causing its accuracy to drop further, triggering further deprioritization of additional classes. Within several epochs, all classes fell below 95%, all were deprioritized to weight 0.1 (effectively reducing the learning rate by 90%), and the model's accuracy collapsed to approximately 10% (random performance), from which it could not recover. This catastrophic failure demonstrates that the 25% threshold is not an arbitrary choice but represents a stability boundary inherent to the method. Below 25%, the protocol is self-correcting: even one epoch of mediocre learning pushes most classes above the threshold. Above a critical threshold (which depends on the task but is significantly below 100%), the protocol enters a destructive positive feedback loop. The claimed threshold of ≤25% is therefore a specifically engineered parameter choice that ensures the method operates in its stable regime.
Experiment 8: Persistent Initialization Imprint and Collapse Reduction. The inventor compared the persistent imprint embodiment (Phase 1 deprioritization weight of 0.99 applied at initialization and carried forward without reset into Phase 2) against Phase 2 alone (dynamic boosting with no Phase 1 assessment), using a 128-64-10 neural network architecture trained on clean 10-class digit data at a high convergence threshold of 94% (near the network's ceiling accuracy). Twenty random seeds were tested for each method, with a maximum of 150 training epochs. Results:
Phase 2 alone: Mean 32.6 epochs to 94%, 20/20 seeds reached threshold.
Persistent imprint (dep=0.99): Mean 32.1 epochs to 94%, 20/20 seeds reached threshold.

Both methods reached the target in all 20 seeds, and convergence speed was comparable. However, the training stability profiles differed substantially:
Phase 2 alone: 83 total collapse events (accuracy drops >2pp from peak), 14/20 seeds affected, worst seed had 43 collapse events.
Persistent imprint: 66 total collapse events, 11/20 seeds affected, worst seed had 19 collapse events.

The persistent imprint reduced total collapses by 20% (83→66), reduced the number of destabilized seeds by 21% (14→11), and reduced worst-case single-seed collapse severity by 56% (43→19). This stability improvement was achieved with a deprioritization weight of 0.99—a 1% perturbation to class weights applied once at initialization and never reset. The result demonstrates that the Phase 1 stabilization protocol, even at ultra-light magnitudes, leaves a persistent structural bias in the network's weight trajectory that reduces susceptibility to late-training accuracy collapses.
Experiment 9: Trajectory Path Dependence Verification. To verify that the stability improvement in Experiment 8 arises from genuine trajectory path dependence rather than from the initial perturbation itself, the inventor conducted a controlled comparison of persistent imprint deprioritization weights at magnitudes of 0.9999, 0.999, 0.99, 0.98, and 0.95 with a single-epoch Phase 1 followed by weight reset, against the same magnitudes with a persistent imprint (no reset). The single-epoch-with-reset variants produced identical training trajectories to Phase 2 alone, regardless of the deprioritization magnitude, confirming that a single epoch of modified class weights has negligible immediate effect on the network's parameters. In contrast, the persistent imprint variants (no reset) produced measurably different trajectories that diverged from Phase 2 alone over subsequent epochs, with the divergence increasing over time. This confirms that the stability improvement arises from the compounding effect of the persistent weight bias across successive training epochs—the definition of trajectory path dependence—rather than from any immediate effect of the Phase 1 constraint on the network's early weight configuration.

### DISCUSSION OF PRIOR ART AND TEACHING AWAY

The following discussion is provided to document the relationship between the present invention and the prior art, and to establish that the claimed combination is non-obvious.

The universal approach in the prior art for handling class imbalance is to increase the training emphasis on underperforming or underrepresented classes. SMOTE (Chawla et al., 2002) generates synthetic minority class examples. Random oversampling duplicates minority examples. Cost-sensitive learning assigns higher loss weights to minority classes from the start of training. Focal Loss (Lin et al., 2017) down-weights well-classified examples, effectively increasing the relative emphasis on hard examples. Dynamically Weighted Balanced Loss (Fernando & Tsokos, 2021) dynamically weights each data instance based on prediction scores. Adaptive Class Weight Dual Focal Loss (2019) makes the class weight scaling coefficient learnable during training. In every case, the approach is to boost the influence of hard or underperforming classes immediately and continuously.

The present invention's Phase 1 does the opposite: it constrains the influence of low-confidence classes during early training. A person of ordinary skill in the art, following the teachings of the cited references, would not arrive at this approach because it appears to make the class imbalance problem worse, not better. The experimental data confirms that doing what the prior art teaches—boosting hard classes during Phase 1 and constraining them during Phase 2 (the “reversed” approach)—produces results that are catastrophically worse than even standard unweighted training (63% to 209% slower, with many runs failing to converge entirely). The prior art does not merely fail to teach the claimed Phase 1 constraint; it actively teaches against it.

The non-obvious insight of the present invention is that the timing of class weight adjustment relative to the model's confidence development is critical. The prior art treats class imbalance as a static property of the dataset to be corrected from the outset. The present invention treats it as a dynamic phenomenon that requires different interventions at different stages of training: constraint during the unstable early phase (to prevent premature pathway commitment), followed by targeted boosting during the stable later phase (to accelerate convergence on the classes that form the accuracy bottleneck). The experimental results demonstrate that this two-phase approach, with the specific ordering of constraint followed by boost, produces statistically significant improvements, while the reversed ordering (boost followed by constraint) is destructive.

Furthermore, none of the prior art teaches Phase 2's accuracy-gap-proportional class weight adjustment. Focal Loss operates at the sample level based on prediction confidence, not at the class level based on accuracy gap from a target. Cost-sensitive learning uses fixed weights proportional to inverse class frequency, not dynamic weights proportional to accuracy gap. DWB Loss operates at the sample level based on prediction scores. The proportional Phase 2 adjustment—measuring each class's accuracy against a target and scaling the boost proportional to the gap—is a distinct mechanism that produces measurably stronger results than uniform boosting (19.8% vs. 11.8% speedup, p=0.002 vs. p=0.03).

The experimental results constitute objective evidence of unexpected results under the Graham factors (Graham v. John Deere Co., 383 U.S. 1 (1966)). Specifically: (a) the mid-training accuracy dip followed by accelerated convergence is a technical improvement not predicted by any combination of the cited references; (b) the prevention of late-training accuracy collapses is an unexpected structural benefit that arises from the Phase 1 constraint; (c) the gradient signal inversion at epoch 22 is a quantitative phenomenon not described or suggested by any prior art; (d) the finding that the reversed approach (which follows the prior art's teachings) is catastrophically worse than both the claimed method and standard training is a result that would surprise a person of ordinary skill; and (e) the discovery that a 1% class weight perturbation at initialization, when persisted without reset, produces 20% fewer training collapses 30-40 epochs later through trajectory path dependence is a result that contradicts the conventional understanding that gradient descent washes out initial conditions, and would be unexpected to a person of ordinary skill.

### FIGURE DESCRIPTIONS

FIG. 1 is a flowchart illustrating the overall method of the present invention, including Phase 1 (Initial Stabilization), the Phase Transition, and Phase 2 (Dynamic Proportional Adjustment). Please note in Figure the 0.99 deprioritization “dep” weight is used, but any value highlighted in this specification would suffice.

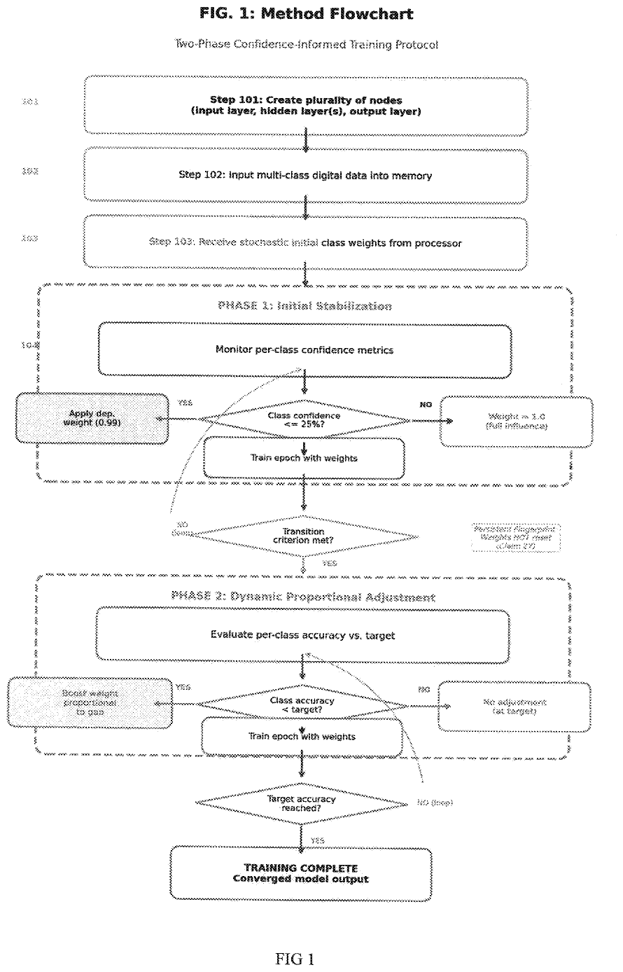

FIG. 2 is a block diagram of the neural network training system, showing the Confidence Assessment Module, the Class Weight Adjustment Module, the Phase Transition Module, the Dynamic Adjustment Module, and the Sample Confidence Module.

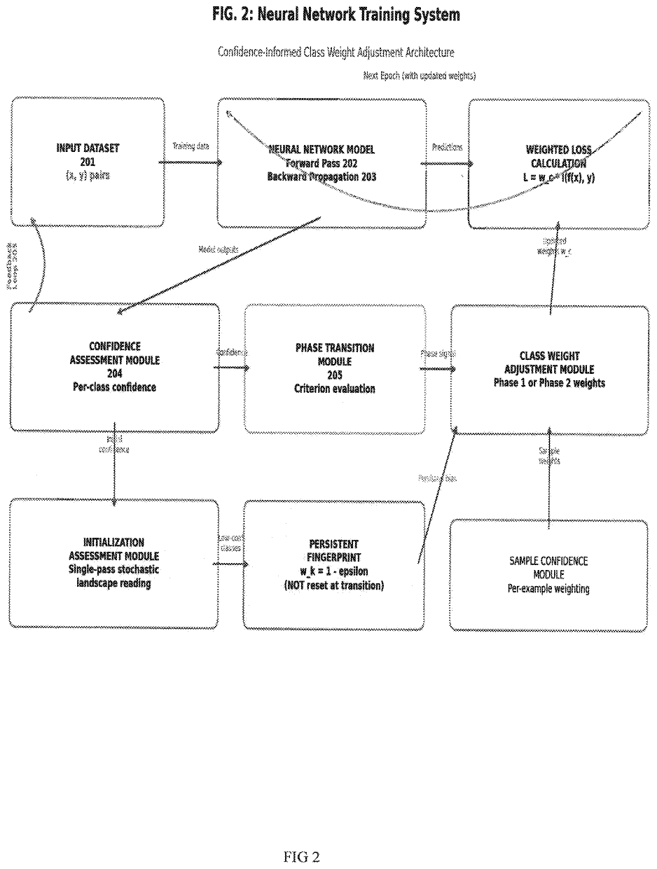

FIG. 3 is a block diagram of the Neural Network Early Pathway Training Stabilizer Module as implemented in a server computing system.

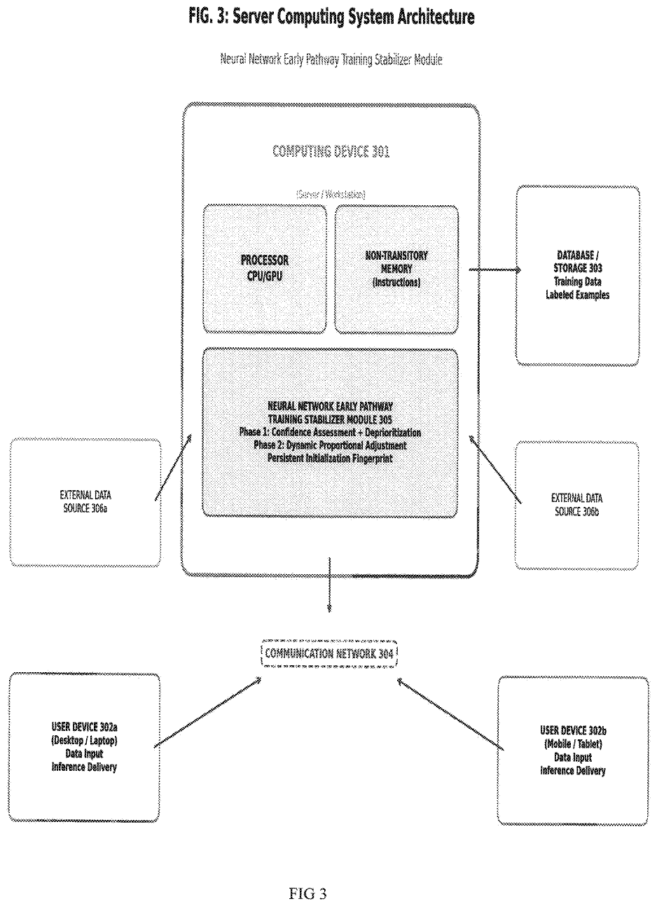

I claim:

1. A digital initialization imprint for an artificial neural network stored in a non-transitory memory, said digital initialization imprint comprising a set of stable neural pathway selection biases formed by: (a) initializing an artificial neural network with stochastic weights via a processor; (b) evaluating, by the processor, per-class confidence metrics of the initialized network to identify classes having confidence at or below a stability threshold of less than or equal to 25 percent; and (c) applying a targeted class weight intervention based on the per-class confidence metrics of step (b) to produce the digital initialization imprint, wherein said imprint defines a structural bias that persists throughout a subsequent training trajectory that prevents model collapses during the training of the artificial neural network.

2. A method for stabilizing the early neural pathways of an artificial neural network (ANN), the method comprising: (a) creating a plurality of nodes with at least one input layer, at least one hidden layer, and at least one output layer; (b) inputting multi-class digital data into a memory; (c) receiving from a processor initial class weights for said multi-class data set stochastically from said processor; and (d) beginning executing an initial training phase comprising: monitoring the model's confidence metrics generated by said processor for the said input data; detecting a specific data subset having a confidence metric at or below a stability threshold set to a value less than or equal to 25 percent and triggering a stabilization protocol that modifies a parameter update sequence by constraining the influence of said detected data written to the memory for the plurality of nodes, thereby inhibiting the effect of said detected data below the stabilization threshold from causing destabilizing model updates in the plurality of nodes and thereby forming stable neural pathways, further comprising a step subsequent to the initial training phase, wherein the processor institutes a dynamic training phase by discontinuing an application of the predetermined stability threshold and instead dynamically adjusting a training focus in real-time based on ongoing class confidence levels to reinforce stable neural pathways, wherein dynamically adjusting the training focus comprises adjusting class weights proportionally to a difference between each class's accuracy and a target accuracy, whereby classes furthest from the target accuracy receive proportionally greater training emphasis.

3. A server computing system comprising: a processor; and a non-transitory memory storing a set of instructions, the instructions when executed by the processor causing the system to perform operations comprising: (a) creating a plurality of nodes with at least one input layer, at least one hidden layer, and at least one output layer; (b) inputting multi-class digital data into the same or a linked set of memory; (c) receiving from a processor initial class weights for said multi-class data set stochastically from said processor; and (d) beginning executing an initial training phase comprising: monitoring the model's confidence metrics generated by said processor for the said input data; detecting a specific data subset having a confidence metric at or below a stability threshold set to a value less than or equal to 25 percent and triggering a stabilization protocol that modifies a parameter update sequence by constraining the influence of said detected data written to the memory for the plurality of nodes, thereby inhibiting the effect of said detected data below the stabilization threshold from causing destabilizing model updates in the plurality of nodes and thereby forming stable neural pathways, wherein said instructions, when executed by the processor, cause the system to perform a further operation subsequent to the initial training phase, the further operation comprising: instituting a dynamic training phase by discontinuing an application of the predetermined stability threshold and instead dynamically adjusting a training focus in real-time based on ongoing class confidence levels to reinforce stable neural pathways, wherein dynamically adjusting the training focus comprises adjusting class weights proportionally to a difference between each class's accuracy and a target accuracy, whereby classes furthest from the target accuracy receive proportionally greater training emphasis.

4. The method of claim 2, wherein the transition from the initial training phase to the dynamic training phase comprises a gradual interpolation of class weights from stabilization weights to dynamic adjustment weights over a plurality of transition epochs, whereby the training protocol shifts smoothly from stabilization to dynamic adjustment.

5. The server computing system of claim 3, wherein the transition from the initial training phase to the dynamic training phase comprises a gradual interpolation of class weights from stabilization weights to dynamic adjustment weights over a plurality of transition epochs, whereby the training protocol shifts smoothly from stabilization to dynamic adjustment.

6. The method of claim 2, further comprising: for each training example, computing a per-example confidence metric representing the model's predicted probability for the true class of said example; and for each training example whose per-example confidence metric falls below a sample-level threshold, reducing a gradient contribution of said example by a sample-level deprioritization weight, wherein the sample-level deprioritization weight is greater than zero and less than one.

7. The method of claim 2, wherein the predetermined stability threshold decays over successive training epochs, whereby the stabilization protocol gradually reduces in scope as the model's confidence develops.

8. The method of claim 2, wherein adjusting class weights proportionally comprises: for each class whose accuracy falls below the target accuracy, computing a gap value representing the difference between the target accuracy and the class's current accuracy; scaling a base boost factor by a ratio of the gap value to the target accuracy to produce a class-specific adjustment factor; and applying the class-specific adjustment factor to increase the class weight, wherein classes with a larger gap value receive a larger increase to their class weight than classes with a smaller gap value, and wherein no adjustment is applied to classes whose accuracy meets or exceeds the target accuracy.

9. The method of claim 2, wherein the dynamic training phase comprises periodically evaluating each class's accuracy relative to the target accuracy and increasing the class weight for each class whose accuracy falls below the target by a uniform multiplicative factor.

10. A method for training an artificial neural network with improved convergence efficiency, the method comprising: (a) during a first plurality of training epochs, monitoring per-class confidence metrics and applying a deprioritization weight to classes having confidence below a stability threshold of less than or equal to 25 percent, thereby preventing gradient updates from unreliable predictions from forming unstable neural pathways; (b) transitioning from the first plurality of training epochs to a second plurality of training epochs when a transition criterion is satisfied; and (c) during the second plurality of training epochs, periodically evaluating per-class accuracy relative to a target accuracy and adjusting class weights proportionally to the gap between each class's accuracy and the target accuracy, whereby classes furthest from the target accuracy receive proportionally greater training emphasis; wherein the combination of steps (a) through (c) produces faster convergence to the target accuracy than standard training with uniform class weights, and produces faster convergence than the reversed sequence of boosting underperforming classes during the first plurality of epochs followed by constraining them during the second plurality of epochs.

11. The method of claim 2, wherein when a proposed parameter update has a magnitude that, as measured by a bounded saturation function, exceeds a regulation threshold, the processor computes a scaling factor and applies a scaled parameter update that preserves the direction of the proposed update while reducing its magnitude to satisfy the regulation threshold, whereby the directional information of the gradient signal is retained while preventing single-step destabilization of the neural pathways.

12. The server computing system of claim 3, wherein when a proposed parameter update has a magnitude that, as measured by a bounded saturation function, exceeds a regulation threshold, the processor computes a scaling factor and applies a scaled parameter update that preserves the direction of the proposed update while reducing its magnitude to satisfy the regulation threshold, whereby the directional information of the gradient signal is retained while preventing single-step destabilization of the neural pathways.

13. The method of claim 2, further comprising: computing, after each training epoch, a per-step trajectory contribution by applying a bounded saturation function to the magnitude of the parameter update for said epoch; monitoring the per-step trajectory contribution over a plurality of consecutive epochs; and detecting convergence of the training when the per-step trajectory contribution falls below a convergence threshold for a predetermined number of consecutive epochs, whereby convergence is detected based on the internal dynamics of the parameter trajectory independently of a validation accuracy metric.

14. The method of claim 13, wherein upon detecting convergence, the processor automatically performs one of: terminating the training, reducing a learning rate, or transitioning from the dynamic training phase to a fine-tuning phase.

15. The method of claim 2, further comprising: computing a cumulative trajectory value by summing the bounded saturation function applied to the magnitude of each parameter update across all completed training epochs; computing a utilization ratio by dividing the cumulative trajectory value by a predetermined training trajectory budget; and managing the training process based on the utilization ratio, wherein when the utilization ratio approaches a predetermined threshold, the processor performs one of: signaling that the training process has consumed substantially all of its variation budget, terminating training, or reallocating computational resources.

16. The server computing system of claim 3, wherein the instructions further cause the system to: compute a cumulative trajectory value by summing a bounded saturation function applied to the magnitude of each parameter update across all completed training epochs; compute a utilization ratio by dividing the cumulative trajectory value by a predetermined training trajectory budget; and manage the training process based on the utilization ratio.

17. The method of claim 2, wherein the constraining of the influence of the detected data during the initial training phase produces a set of initialization-informed class weights, and wherein said initialization-informed class weights persist into the dynamic training phase without being reset to uniform values, whereby the dynamic training phase operates upon the initialization-informed class weights and the influence of the initial stabilization compounds across successive dynamic adjustments.

18. The server computing system of claim 3, wherein the constraining of the influence of the detected data during the initial training phase produces a set of initialization-informed class weights, and wherein said initialization-informed class weights persist into the dynamic training phase without being reset to uniform values, whereby the dynamic training phase operates upon the initialization-informed class weights and the influence of the initial stabilization compounds across successive dynamic adjustments.

19. The method of claim 17, wherein the deprioritization weight applied during the initial training phase is within 5% of unity, and wherein the persistent influence of said deprioritization weight produces a measurable reduction in training accuracy collapse events during later training epochs relative to the dynamic training phase operating with uniform initial class weights, whereby a perturbation of less than 5% to initial class weights produces a statistically distinguishable training stability profile through trajectory path dependence.

20. The method of claim 2, wherein the initial training phase comprises a single-pass assessment performed before or during a first training epoch, said assessment comprising: evaluating per-class confidence metrics of the model based on the stochastically initialized network weights; and setting class weights for classes having confidence at or below the stability threshold to a deprioritization weight less than 1.0, whereby the assessment reads information from the stochastic initialization regarding which classes are predisposed to unstable learning and applies a targeted class weight intervention based on said information.

21. The server computing system of claim 3, wherein the initial training phase comprises a single-pass assessment performed before or during a first training epoch, said assessment comprising: evaluating per-class confidence metrics of the model based on the stochastically initialized network weights; and setting class weights for classes having confidence at or below the stability threshold to a deprioritization weight less than 1.0, whereby the assessment reads information from the stochastic initialization regarding which classes are predisposed to unstable learning and applies a targeted class weight intervention based on said information.

22. A method for reducing training instability in an artificial neural network, the method comprising: (a) initializing an artificial neural network with stochastic weights; (b) evaluating per-class confidence metrics of the initialized network to identify classes having confidence at or below a stability threshold of less than or equal to 25 percent; (c) applying a persistent deprioritization weight to the identified classes, wherein the persistent deprioritization weight is less than 1.0 but greater than zero; (d) training the artificial neural network using a dynamic class weight adjustment protocol that periodically increases weights for classes whose accuracy falls below a target accuracy; wherein the persistent deprioritization weight from step (c) is not reset to a uniform value before or during the training of step (d), whereby the persistent deprioritization weight compounds with the dynamic adjustments of step (d) across successive training epochs, and whereby the method produces fewer training accuracy collapse events than the dynamic class weight adjustment protocol of step (d) applied with uniform initial class weights.

23. A method for training an artificial neural network, comprising: (a) obtaining a digital initialization imprint for a model, and (b) using the said digital initialization imprint throughout the model's training to prevent collapses by allowing the said digital initialization imprint's weight biases to influence the selection of weights and connections through the said . . . artificial neural network's training.

24. The method of claim 2, further comprising: identifying one or more re-dampening epochs during training at which confidence-based class weight dampening is re-applied after the initial Phase 1 stabilization period; at each re-dampening epoch, re-invoking the confidence scanner to assess per-class confidence levels and identify classes having a confidence level at or below the confidence threshold; computing re-dampening weights for the identified classes using the confidence-based weighting protocol; applying the re-dampening weights for a re-dampening window comprising a predetermined number of training epochs; and releasing the re-dampening weights and resuming dynamic training focus adjustment after the re-dampening window, wherein each re-dampening event induces a temporary reduction in per-epoch accuracy gain followed by an amplified accuracy gain recovery in the subsequent training window.

25. The server computing system of claim 3, wherein the one or more processors are further configured to: maintain a schedule of one or more re-dampening epochs; at each scheduled re-dampening epoch, re-assess per-class confidence levels using the confidence scanner; apply confidence-based class weights for a re-dampening window following each scheduled re-dampening epoch; and resume the dynamic training focus adjustment protocol after the re-dampening window expires.

26. The method of claim 2, further comprising: monitoring a current learning velocity comprising a per-epoch accuracy gain over a current measurement window; maintaining a reference learning velocity comprising an average per-epoch accuracy gain over a prior reference window; computing a velocity ratio comprising the current learning velocity divided by the reference learning velocity; determining that a re-dampening condition is satisfied when the velocity ratio falls below a velocity trigger threshold and a per-class accuracy spread exceeds a minimum spread threshold; upon determining the re-dampening condition is satisfied, re-invoking the confidence scanner and applying confidence-based re-dampening weights for a re-dampening window; and resuming the dynamic training focus adjustment protocol after the re-dampening window, wherein the re-dampening condition is evaluated at each training epoch and re-dampening events are subject to a minimum inter-event interval.

27. The server computing system of claim 3, wherein the one or more processors are further configured to: monitor per-epoch accuracy gain and maintain a rolling velocity ratio comparing current velocity to a reference velocity; detect a velocity trigger condition comprising the velocity ratio falling below a predetermined threshold while a per-class accuracy spread exceeds a minimum spread threshold; upon detecting the velocity trigger condition, apply confidence-based re-dampening weights for a configurable re-dampening window; and resume dynamic training focus adjustment after the re-dampening window, subject to a minimum interval between consecutive re-dampening events.

28. A method for training an artificial neural network using unified trajectory control, the method comprising: (a) creating, via a processor, a plurality of nodes with at least one input layer, at least one hidden layer, and at least one output layer for an artificial neural network, and inputting multi-class digital data into a memory; (b) receiving initial class weights for said multi-class digital data stochastically from the processor, and executing a single-pass assessment comprising evaluating per-class confidence metrics of the artificial neural network to identify classes having a confidence metric at or below a stability threshold set to a value less than or equal to 25 percent; (c) executing an initial training phase comprising triggering a stabilization protocol that applies a deprioritization weight less than 1.0 but greater than zero to the identified classes having the confidence metric at or below the stability threshold, thereby modifying a parameter update sequence by constraining the influence of data associated with the identified classes and inhibiting destabilizing model updates in the plurality of nodes to form stable neural pathways; (d) instituting a dynamic training phase subsequent to the initial training phase by discontinuing the stabilization protocol and instead dynamically adjusting a training focus in real-time by adjusting the class weights proportionally to a difference between each class's accuracy and a target accuracy, whereby classes furthest from the target accuracy receive proportionally greater training emphasis; and (e) monitoring a per-epoch accuracy gain during the dynamic training phase to maintain a rolling velocity ratio comparing a current learning velocity to a reference learning velocity, and upon determining that a re-dampening condition is satisfied-comprising the rolling velocity ratio falling below a velocity trigger threshold while a per-class accuracy spread exceeds a minimum spread threshold temporarily suspending the dynamic training phase to apply confidence-based re-dampening weights for a configurable re-dampening window before resuming the dynamic training phase.

29. A server computing system acting as a unified trajectory controller for an artificial neural network, the server computing system comprising: a processor; and a non-transitory memory storing a set of instructions, the instructions when executed by the processor causing the server computing system to perform operations comprising: (a) creating an artificial neural network comprising a plurality of nodes with at least one input layer, at least one hidden layer, and at least one output layer, and inputting multi-class digital data into the memory; (b) receiving initial class weights for said multi-class digital data stochastically from the processor, and executing a single-pass assessment comprising evaluating per-class confidence metrics of the artificial neural network to identify classes having a confidence metric at or below a stability threshold set to a value less than or equal to 25 percent; (c) executing an initial training phase comprising triggering a stabilization protocol that applies a deprioritization weight less than 1.0 but greater than zero to the identified classes having the confidence metric at or below the stability threshold, thereby modifying a parameter update sequence by constraining the influence of data associated with the identified classes and inhibiting destabilizing model updates in the plurality of nodes to form stable neural pathways; (d) instituting a dynamic training phase subsequent to the initial training phase by discontinuing the stabilization protocol and instead dynamically adjusting a training focus in real-time by adjusting the class weights proportionally to a difference between each class's accuracy and a target accuracy, whereby classes furthest from the target accuracy receive proportionally greater training emphasis; and (e) monitoring a per-epoch accuracy gain during the dynamic training phase to maintain a rolling velocity ratio comparing a current velocity to a reference velocity, and upon detecting a velocity trigger condition comprising the rolling velocity ratio falling below a predetermined threshold while a per-class accuracy spread exceeds a minimum spread threshold, temporarily suspending the dynamic training phase to apply confidence-based re-dampening weights for a configurable re-dampening window before resuming the dynamic training phase.
